(19) United States
(12) Patent Application Publication
(10) Pub. No.: US 2025/0170712 A1
(43) Pub. Date: May 29, 2025

(54) ANGLE COMPENSATION UNIT WITH CONTROL AND LOCKING PISTON, CLAMPING AND/OR GRIPPING DEVICE, AND HANDLING DEVICE

(71) Applicant: SCHUNK SE & Co. KG Spanntechnik Greiftechnik Automatisierungstechnik, Lauffen am Neckar (DE)

(72) Inventors: Johannes Uhler, Ittlingen (DE); Daniel Barta, Untergruppenbach (DE)

(21) Appl. No.: 18/961,699

(22) Filed: Nov. 27, 2024

(30) Foreign Application Priority Data
Nov. 29, 2023 (DE) 10 2023 133 422.0

(51) Int. Cl. B25J 9/16; B25J 9/10; B25J 13/08; B25J 15/00

(52) U.S. Cl. CPC B25J 9/1641; B25J 9/101; B25J 9/1612; B25J 13/088; B25J 15/00

(57) ABSTRACT

This disclosure relates to an angle compensation unit for a handling device, having a base part and a compensating part. The compensating part is pivotable relative to the base part about an x-axis and about a y-axis running perpendicular to the x-axis between a basic position and a compensating position. A bearing frame and a bearing flange are arranged in the base part, wherein the bearing frame is mounted in the base part in a manner allowing rotation about the x-axis. The bearing flange is mounted in the bearing frame in a manner allowing rotation about the y-axis.

### TECHNICAL FIELD

This disclosure relates to an angle compensation unit, to a clamping and/or gripping device, and to a handling device.

### BACKGROUND

Compensation units, in particular angle compensation units, are suitable for arranging on an automation system, in particular for arranging between a handling device and a tool, and have a base part and a compensating part, the compensating part being arranged such that it can be moved in relation to the base part along at least one compensating direction from a basic position into a compensating position, and have spring means for returning the compensating part from the into the basic position. The base part can be designed to be fastened to a handling device and/or a tool, and the compensating part can be designed to be fastened to a tool and/or a handling device.

The applicant's compensation unit AGE-U, which is disclosed in current catalog materials, is a known embodiment of a compensation unit for carrying out an angle compensating movement.

DE 10 2021 126 756 A1 discloses a collision protection device for a processing head of a laser processing machine with a cardan joint. DE 10 2016 212 141 A1, DE 36 05 505 A1 and DD 1 43 226 A1 likewise disclose collision protection devices. DE 10 2021 130 322 A1 discloses a cardan suspension for a detected device. DE 10 2020 100 435 A1 discloses a robot tool with selectable yield moduli.

### SUMMARY

The disclosure is based on the object of creating an angle compensation unit which has a high load-bearing capacity.

The object of the disclosure is achieved by an angle compensation unit having the features of claim 1. The angle compensation unit has a base part and a compensating part. The compensating part can be pivoted relative to the base part along at least one compensating direction about an x-axis and about a y-axis between a basic position and a compensating position. The y-axis is perpendicular to the x-axis. A bearing frame and a bearing flange are arranged in the base part. The bearing frame is mounted on the base part so that it can rotate around the x-axis. The bearing flange is mounted in the bearing frame so that it can rotate around the y-axis. The combination of the bearing frame and the bearing flange is based on a cardanic suspension. The bearing frame and bearing flange are also referred to as the “cardan joint” below.

Due to the design of the bearing frame and the bearing flange, forces can be distributed across different bearing components, ensuring high load-bearing capacity, particularly for axial forces.

In the basic position, the compensating part is arranged perpendicular to a z-axis. A z-axis extends perpendicular to the x-axis and the y-axis. In the compensating position, the compensating part is not arranged vertically, but rather at an angle to the z-axis.

The angle compensation unit has a control piston—in particular, pneumatically and/or hydraulically driven—for controlling the pivoting moment and/or release moment, wherein the control piston is displaceable along a z-axis running perpendicular to the x-axis and the y-axis between a lower control position and an upper release position. In order to prevent the movement of the cardan joint, in particular an unwanted rotation about the x-axis and the y-axis and a movement of the compensating part, for example due to the dead mass of a screwed-on actuator in the horizontal position of the angle compensation unit, the control piston, in particular a single-acting piston, is provided, such the cardan joint and thus the compensating part can only be moved above a certain pivoting moment. Consequently, the force acting on the compensating part must first overcome the pivoting moment in order to move the compensating part from the basic position to the compensating position.

The angle compensation unit further comprises a locking piston, in particular pneumatically and/or hydraulically driven, for locking the compensating part. The locking piston is movable along the z-axis between an upper unlocked position and a lower locking position. In the locking position, angle compensation using the compensating part is not possible. In the unlocked position, angle compensation is possible.

The locking piston and the control piston are coupled in such a way that a displacement of the locking piston into the locking position also causes a displacement of the control piston into the control position. For this purpose, the force of the locking piston is transferred to the control piston by means of the first spring means. It is also conceivable that the locking piston contacts the control piston in the locking position and thus directly transmits the force for displacement. Consequently, the bearing flange and thus the compensating part is locked by means of the control piston.

The base part preferably has a connection housing and/or a cardan housing, wherein the cardan housing is preferably connected to the connection housing in a manner preventing movement—in particular, screwed. It is advantageous if the bearing frame and the bearing flange are arranged in the cardan housing. It is also advantageous if the bearing frame is mounted in the cardan housing so that it can rotate about the x-axis. The connection housing is preferably closed off on the top side of the base part by means of a housing cover.

An advantageous further development provides that the compensating part is connected to the bearing flange in a manner preventing movement. Accordingly, the freedom of movement achieved by the bearing frame and the bearing flange is provided in the compensating part.

It is advantageous if the bearing frame has a first axis of rotation running along the x-axis and the bearing flange has a second axis of rotation running along the y-axis, wherein the first axis of rotation and the second axis of rotation lie in a plane of rotation running perpendicular to the z-axis. Due to the arrangement of the axes of rotation in a common plane or the arrangement of the bearing frame and the bearing flange radially adjacent with respect to the z-axis, the angle compensation unit, in particular the base part and/or the cardan housing, is particularly flat.

It is further advantageous if the bearing frame is rotatably mounted in the base part, in particular in the cardan housing, by means of a first pivot pin extending along the x-axis. It is also advantageous if the bearing flange is rotatably mounted in the bearing frame by means of a second pivot pin extending along the y-axis. The pivot pins represent a simple way of supporting the bearing frame and/or the bearing flange.

A further advantageous embodiment provides that the bearing frame is ring-shaped, in particular perpendicular to the z-axis. Preferably, the bearing frame has a flange receptacle for receiving the bearing flange. The bearing frame is preferably rounded on a first outer surface, in particular convexly, wherein the rounding preferably runs or is visible in a cross-section along the z-axis. Preferably, first pin receptacles for receiving the first pivot pins are provided in the first outer surface.

A further advantageous embodiment provides that the bearing flange is partially spherical. A second outer surface of the bearing flange preferably runs along a spherical surface in a central region relative to the z-axis. The bearing frame preferably has an inner surface oriented towards the z-axis, which is preferably concavely rounded. The bearing flange can be guided along the inner surface of the bearing frame. The central regions of the bearing flange and the bearing frame are preferably designed to be complementary to each other. In the central region of the bearing flange, second pin receptacles are preferably provided to accommodate the second pivot pins.

Rotation about the z-axis is suppressed due to the pivot pins. A translational displacement of the bearing flange and thus of the compensating part is prevented by a spherical shape on the outer surfaces of the bearing flange or bearing ring as well as a hemispherical shape of the same diameter on the inner guide surfaces in the cardan housing and in the bearing ring. At the same time, these spherical contact surfaces continue to allow rotation around the axes not locked by pivot pins, namely the x-axis and the y-axis, which makes angle compensation possible.

To return the control piston to the control position, a first spring means, in particular a compression spring, is preferably provided. Consequently, the control piston is moved into the control position even when the power is off, and thus the compensating part is also returned to the basic position when the power is off.

Preferably, the control piston has a control surface and the bearing flange has a flange surface, which contact and interact to return the compensating part to the basic position. The control surface and/or the flange surface can be flat, in particular running perpendicular to the z-axis in the basic position of the compensating part. Alternatively, the control surface is formed by a mandrel protruding along the z-axis. Alternatively, the flange surface is formed by a recessed pocket along the z-axis. It is also conceivable that the pocket is arranged on the control piston and the mandrel on the bearing flange.

It is advantageous if the mandrel and/or the pocket are conical and/or complementary to each other. The conical surfaces enable greater force transmission and thus a higher locking torque. Preferably, the pocket tapers away from the mandrel. Preferably, the mandrel tapers towards the pocket.

It is further advantageous if the mandrel and/or the pocket are designed as inserts, in particular designed separately from the control piston and/or the bearing flange. Accordingly, the mandrel and/or the pocket may be made of a different material than the control piston and/or the bearing flange. For example, the inserts can have a higher wear resistance than the other components, while the other components are designed for a lightweight construction. The inserts can preferably be designed as wear inserts.

Preferably, the base part, in particular the connection housing, and the control piston delimit a pressurizable first pressure chamber. When the first pressure chamber is pressurized, the control piston is moved from the release position to the control position additionally to the spring force of the first spring means, so that the compensating part is moved to the basic position. In order to pivot the compensating part in the compensating direction, the pivoting moment caused by the control piston, and in particular the first spring means, must first be overcome. This allows a continuous adjustment of the pivoting moment. Such a continuous adjustment is particularly important for horizontal applications or when the center of gravity of the tools is not on the same z-axis as the compensating part.

A second spring means, in particular two compression springs, is provided to return the locking piston to the unlocked position. Consequently, the locking piston is moved into the unlocked position in the de-energized state and thus the compensating part can be pivoted into the compensating position in the de-energized state.

It is advantageous if the base part, in particular the connection housing and the housing cover, and the locking piston delimit a second pressure chamber that can be pressurized. When the second pressure chamber is pressurized, the locking piston is moved from the unlocked position into the locking position against the spring force of the second spring means, and in particular against the spring force of the first spring means, so that the compensating part is displaced into the basic position and locked there. The locking position can be provided along the entire stroke path of the locking piston. It is conceivable that the locking piston is only displaced by a portion of the stroke path along the z-axis, so that the maximum pivoting angle of the compensating part can be limited. This allows a continuous adjustment of the maximum pivoting angle.

The first spring means is preferably supported on the control piston and the locking piston. The second spring means is preferably supported on the locking piston and the connection housing.

A further advantageous development provides that the angle compensation unit has a sensor device with a position sensor for detecting the position of the locking piston and/or the control piston and/or the bearing frame and/or the bearing flange and/or the compensating part, and/or a presence sensor for detecting the presence of a component on the compensating part.

It is advantageous if the angle compensation unit has a controller/regulator. The sensor device preferably transmits the sensor data to the controller/regulator. The controller/regulator preferably controls the pressurization of the first pressure chamber and/or the second pressure chamber according to the received sensor data. Furthermore, the controller/regulator preferably determines the forces and/or moments acting on the compensating part as a function of the positional deviation of the compensating position from the basic position.

To limit the pivoting angle of the compensating part, at least one end stop is preferably provided on the compensating part, which, at the maximum pivoting angle, contacts an bottom side of the base part, in particular an bottom side of the cardan housing. Preferably, the at least one end stop has a conical slope. The slope preferably tapers along the z-axis towards the base part.

The object of the disclosure is likewise achieved by a clamping and/or gripping device having the features of claim 19. The clamping and/or gripping device has an angle compensation unit as described above.

The object of the disclosure is likewise achieved by a handling device having the features of claim 20. The handling device has a previously described angle compensation unit and/or a previously described clamping and/or gripping device.

Further details and advantageous embodiments of the disclosure can be found in the following description, by which embodiments of the disclosure are further described and explained.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 shows a perspective view of an angle compensation unit;

FIG. 2 shows an exploded view of the angle compensation unit according to FIG. 1;

FIG. 3 shows an exploded view of the angle compensation unit according to FIG. 1;

FIG. 4 shows a perspective view of a cardan housing of the angle compensation unit according to FIG. 1;

FIG. 5 shows a sectional view of the angle compensation unit according to FIG. 1, wherein the compensating part is arranged in the basic position;

FIG. 6 shows a sectional view of the angle compensation unit according to FIG. 1, wherein the compensating part is arranged in the compensating position;

FIG. 7 shows a sectional view of the angle compensation unit according to FIG. 1, wherein the locking piston is arranged in the locking position;

FIG. 8 shows a further sectional view of the angle compensation unit according to FIG. 1, wherein the compensating part is arranged in the basic position;

FIG. 9 shows a further sectional view of the angle compensation unit according to FIG. 1, wherein the compensating part is arranged in the compensating position; and

FIG. 10 shows a further sectional view of the angle compensation unit according to FIG. 1, wherein the locking piston is arranged in the locking position.

### DETAILED DESCRIPTION

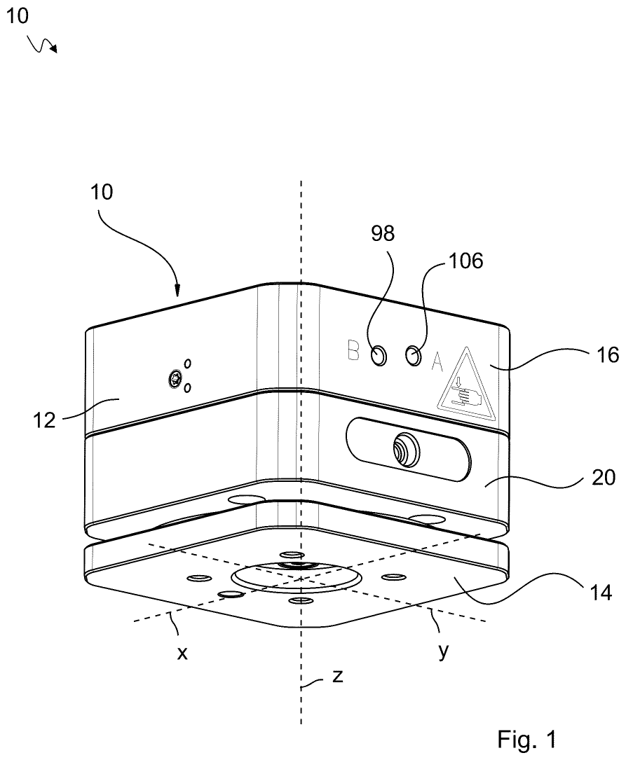

The angle compensation unit 10 is arranged on a handling device not shown, wherein the angle compensation unit 10 can be arranged between a handling device not shown, in particular a robot arm, and a tool not shown, in particular a gripper. According to FIG. 1, the angle compensation unit 10 has a base part 12 and a compensating part 14, wherein the compensating part 14 can be pivoted relative to the base part 12 about an x-axis and about a y-axis running perpendicular to the x-axis between a basic position and a compensating position.

In the basic position, the compensating part 14 is arranged perpendicular to a z-axis according to FIG. 1. A z-axis extends perpendicular to the x-axis and the y-axis. In the compensating position, the compensating part 14 is not arranged vertically, but rather obliquely, to the z-axis.

According to FIG. 1, the base part 12 has a cuboid-shaped connection housing 16 and a cuboid-shaped cardan housing 20 adjacent to the connection housing 16, wherein the cardan housing 20 is connected to the connection housing 16 in a manner preventing movement, in particular screwed. The connection housing 16 is used for arrangement on a handling device. The compensating part 14 is used for arrangement on a tool. The connection housing 16 is closed by a housing cover 18.

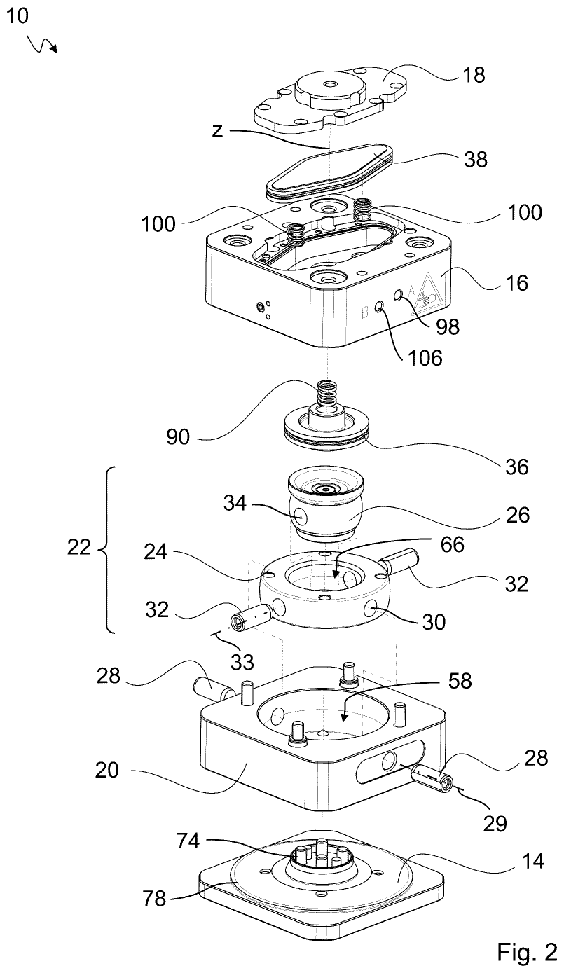

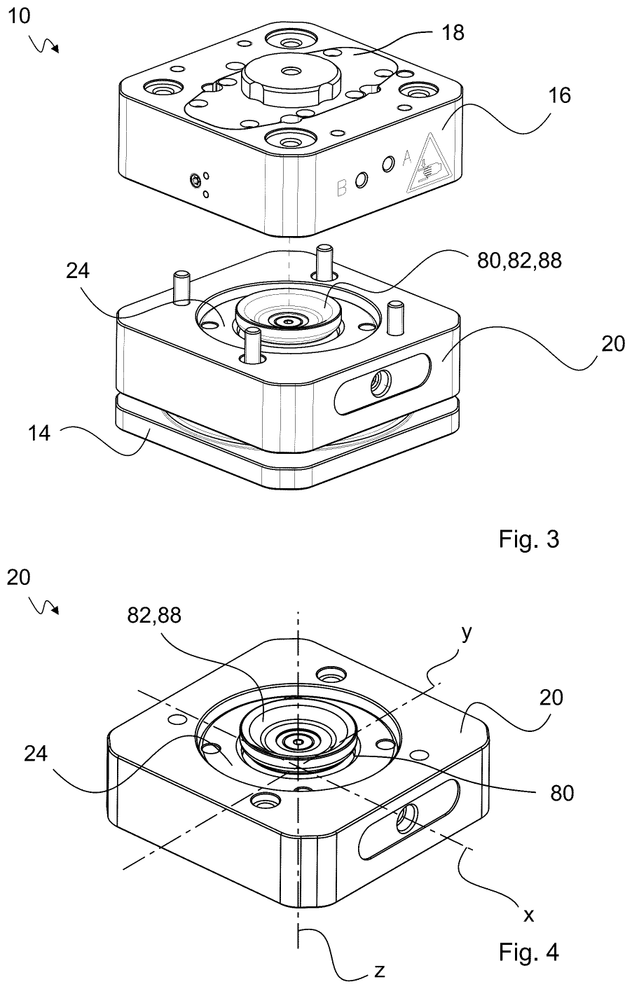

The compensating part 14 and the base part 12 are movably connected to one another by means of a cardan joint 22 as shown in FIGS. 2 to 10. The cardan joint 22 is arranged in the cardan housing 20. According to FIG. 2, the cardan joint 22 has a rotationally symmetrical bearing frame 24 and a rotationally symmetrical bearing flange 26. The bearing frame 24 is rotatably mounted about a first axis of rotation 29 by means of a first pivot pin 28 in the cardan housing 20, wherein the first axis of rotation 29 runs along the x-axis. The bearing frame 24 has first pin receptacles 30 for receiving the first pivot pins 28. The bearing flange 26 is rotatably mounted about a second axis of rotation 33 in the bearing frame 24 by means of second pivot pins 32, wherein the second axis of rotation 33 runs along the y-axis. The first axis of rotation 29 and the second axis of rotation 33 extend in a common plane 35. The bearing flange 26 has second pin receptacles 34 for receiving the second pivot pins 32. The bearing flange 26 is connected to the compensating part 14 in a manner preventing movement. Accordingly, pivoting of the bearing flange 26 also causes pivoting of the compensating part 14 and vice versa.

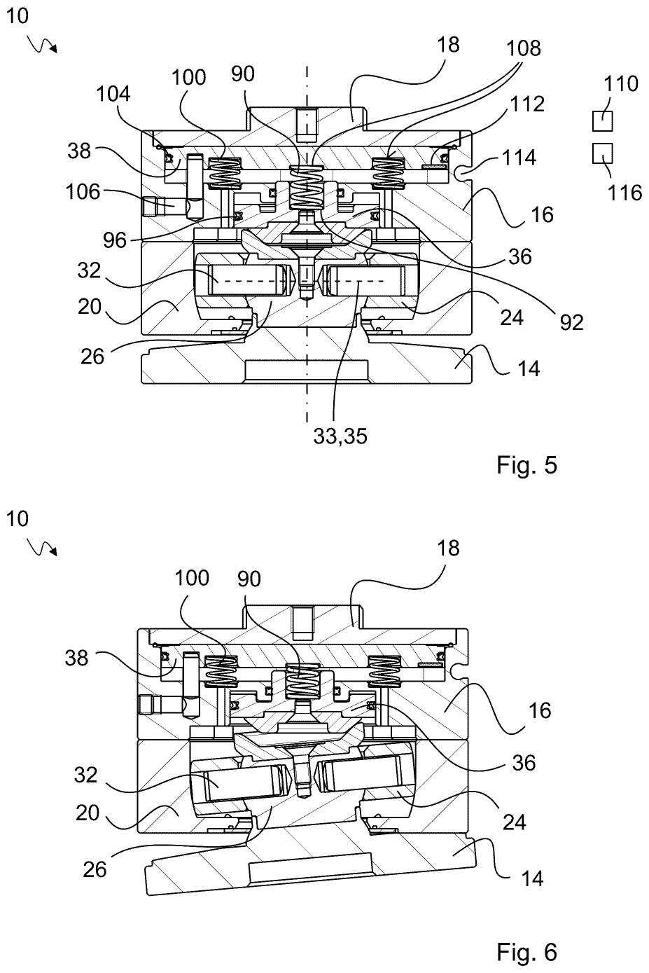

To overcome the continuous adjustment of the pivoting moment, the angle compensation unit 10 according to FIGS. 5 to 10 has a rotationally symmetrical control piston 36, in particular pneumatically and/or hydraulically driven, which compels the bearing flange 26 into the zero position and thus the compensating part 14 into the basic position. To lock the compensating part 14, the angle compensation unit 10 has a locking piston 38, in particular pneumatically and/or hydraulically driven, which compels the bearing flange 26 into the zero position and locks the compensating part 14 in the basic position.

According to FIG. 8, the connection housing 16 has a connection housing top side 40, an opposite connection housing bottom side 42, and a connection housing lateral surface 44. The cardan housing has a cardan housing top side 46, an opposite cardan housing bottom side 48, and a cardan housing lateral surface 50. The compensating part 14 has a compensating part top side 52, an opposite compensating part bottom side 54, and a compensating part lateral surface 56. In the assembled state, the connection housing top side 40 faces the handling device, the connection housing bottom side 42 faces the cardan housing top side 46, the cardan housing bottom side 48 faces the compensating part top side 52, and the compensating part bottom side 54 faces the tool. The connection housing top side 40 is substantially formed by the housing cover 18.

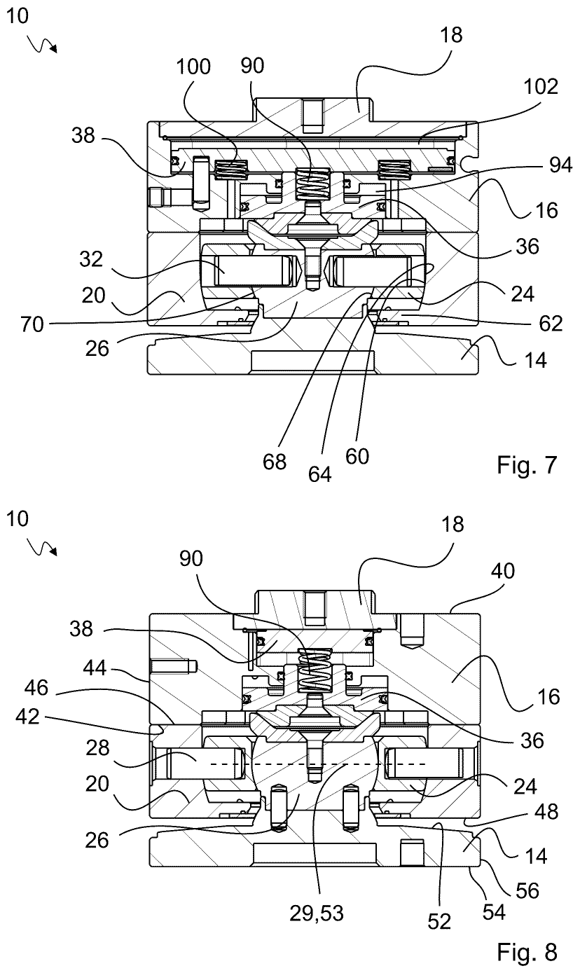

The cardan housing 20 is pot-shaped according to FIGS. 2 to 10 and has a central recess 58 in which the cardan joint 22 is arranged in the assembled state. To guide the bearing frame 24 in the cardan housing 20, the cardan housing 20 according to FIG. 7 has a first guide surface 60 which runs parallel to the z-axis in an upper first portion and runs along a spherical surface or a conical surface in a lower second portion. The first guide surface 60 is delimited by a cardan housing base 62, which substantially forms the cardan housing bottom side 48.

According to FIG. 7, the bearing frame 24 has a first outer surface 64 which comes into contact with the first guide surface 60. The first outer surface 64 runs along a spherical surface. The bearing frame 24 further comprises a flange receptacle 66 for receiving the bearing flange 26, with a second guide surface 68 which also runs along a spherical surface. The bearing frame 24 is circular in shape in a sectional view perpendicular to the z-axis, as in FIGS. 5 to 10. The bearing flange 26 has a second outer surface 70 which runs along a spherical surface and comes into contact with the second guide surface 68. When the bearing flange 26 rotates about the x-axis, the first outer surface 64 slides on the first guide surface 60. When the bearing flange 26 rotates about the y-axis, the second outer surface 70 slides on the second guide surface 68.

According to FIG. 10, the bearing flange 26 has multiple fastening receptacles 76 on a flange bottom side 72 for receiving fastening means 74 arranged on the compensating part top side 52. By means of the fastening means 74 and the fastening receptacles 76, the compensating part 14 and the bearing flange 26 are connected to one another in a manner preventing movement.

To assemble the cardan joint 22, the bearing flange 26 is first inserted into the flange receptacle 66 of the bearing frame 24 as shown in FIG. 2. Subsequently, the second pivot pins 32 are inserted into the second pin receptacles 34 via the first outer surface 64 of the bearing frame 24. Subsequently, the bearing frame 24 together with the bearing flange 26 is inserted into the central recess 58 of the cardan housing 20. Then, the first pivot pins 28 are inserted into the first pin receptacles 30 via the cardan housing lateral surface 50. The compensating part 14 and the bearing flange 26 are then connected to each other.

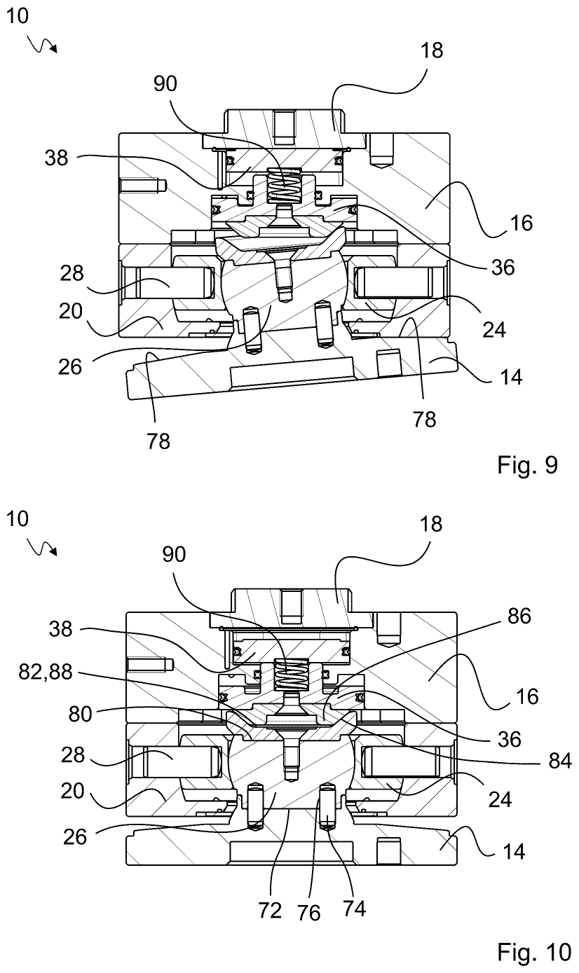

To limit the maximum pivoting angle, the compensating part 14 according to FIG. 9 has an end stop 78 on the compensating part top side 52, which is designed as a conical slope, wherein the slope tapers towards the base part 12. The end stop 78 comes into contact with the cardan housing bottom side 48 in the compensating position when the maximum pivoting angle has been reached by the compensating part 14.

According to FIG. 10, a flange surface 82 is provided on a flange top side 80 of the bearing flange 26, which flange surface contacts and interacts with a control surface 84 of the control piston 36 to return the compensating part 14 to the basic position. The control surface 84 is formed by a mandrel 86 protruding along the z-axis. The flange surface 82 is formed by a pocket 88 recessed back along the z-axis. It is also conceivable that the pocket 88 is arranged on the control piston 36 and the mandrel 86 on the bearing flange 26. The mandrel 86 and the pocket 88 are conical and complementary to each other. The conical surfaces enable greater force transmission and thus a higher locking torque. The pocket 88 tapers away from the mandrel 86. The mandrel 86 tapers towards the pocket 88. The mandrel 86 and the pocket 88 are designed as inserts that are separate from the control piston 36 and/or the bearing flange 26. The mandrel 86 and the pocket 88 are made of a different material, in particular a wear-resistant material, than the control piston 36 and the bearing flange 26, which are made of a lightweight material. The inserts are designed as wear inserts.

To control the locking torque, the control piston 36 is moved along the z-axis from an upper release position to a lower control position. The mandrel 86 and the pocket 88 interact with each other in such a way that the bearing flange 26 is centered and the compensating part 14 is displaced into the basic position. In order to pivot the compensating part 14, the pivoting moment or activation moment resulting from the control piston 36 must be overcome by the force acting on the compensating part 14. A first spring means 90, in particular a compression spring, is provided for returning the control piston 36 to the control position. Consequently, the control piston 36 is moved into the control position even in the de-energized state, and thus the compensating part 14 is also returned to the basic position in the de-energized state. The first spring means 90 extends along the z-axis and is supported on the control piston 36 and the locking piston 38. For this purpose, first spring receptacles 92 are provided on the control piston 36 and on the locking piston 38 as shown in FIG. 5. To allow for continuously adjusting the pivoting moment, the control piston 36 and the connection housing 16 define a first pressure chamber 94. The first pressure chamber 94 is sealed by first sealing means 96 arranged on the connection housing 16 and on the control piston 36. The first pressure chamber 94 can be pressurized by means of at least one first pressure line 98, wherein the first pressure line 98 opens into the connection housing lateral surface 44. When the first pressure chamber 94 is pressurized, the control piston 36 is moved from the release position to the control position, additionally to the spring force of the first spring means 90, so that the compensating part 14 is displaced into the basic position. In order to pivot the compensating part 14 in the compensating direction, the pivoting moment caused by the control piston 36 and the first spring means 90 must first be overcome. This allows a continuous adjustment of the pivoting moment. Such a continuous adjustment is particularly important for horizontal applications or cases in which centers of gravity of the tools that are not on a z-axis with the compensating part 14.

To lock the compensating part 14 in the basic position or the cardan joint 22 in the zero position, the locking piston 38 is displaceable along the z-axis between an upper unlocked position and a lower locking position. In the locking position, angle compensation by means of the compensating part 14 is not possible. In the unlocked position, angle compensation is possible by means of the compensating part 14. The locking piston 38 is substantially diamond-shaped with rounded corners in cross-section perpendicular to the z-axis, being stretched along the y-axis and compressed along the x-axis. A second spring means 100, in particular two compression springs, is provided for returning the locking piston 38 to the unlocked position. Consequently, the locking piston 38 is moved into the unlocked position in the de-energized state and thus the compensating part 14 is unlocked in the de-energized state and can thus be pivoted into the compensating position.

The base part 12, in particular the connection housing 16 and the housing cover 18, and the locking piston 38 delimit a pressurizable second pressure chamber 102 according to FIG. 7. The second pressure chamber 102 is sealed by second sealing means 104 arranged on the connection housing 16 and on the control piston 36. The second pressure chamber 102 can be pressurized by means of at least one second pressure line 106, wherein the second pressure line 106 opens into the connection housing lateral surface 44. When the second pressure chamber 102 is pressurized, the locking piston 38 is moved from the unlocked position into the locking position against the spring force of the second spring means 100 and the first spring means 90, so that the compensating part 14 is displaced into the basic position and locked there. The second spring means 100 extends along the z-axis and is supported on the locking piston 38 and the connection housing 16. For this purpose, second spring receptacles 108 are provided on the locking piston 38 and on the connection housing 16 according to FIG. 5. The locking position can be provided along the entire stroke path of the locking piston 38. It is conceivable that the locking piston is only displaced by a portion of the stroke path along the z-axis, so that the compensating part 14 is not completely locked, and rather only the maximum pivoting angle of the compensating part 14 can be limited beyond the end stop 78. This also allows for continuous adjustment of the maximum pivoting angle.

The angle compensation unit 10 further comprises, according to FIG. 5, a sensor device 110 with a position sensor for detecting the position of the locking piston 38 and/or the control piston 36 and/or the bearing frame 24 and/or the bearing flange 26 and/or the compensating part 14, and/or a presence sensor for detecting the presence of a component on the compensating part 14. A position sensor for detecting the position of the locking piston 38 has a signal generator 112 arranged in the locking piston 38 and a signal receiver arranged in a sensor groove 114 provided on the connection housing lateral surface 44. The signal generator 112 is preferably arranged in a lateral surface of the locking piston 38. The signal generator 112 enters the effective range of the signal receiver as soon as the locking piston 38 is arranged in the locking position. Accordingly, the position sensor detects the locking of the compensating part 14. However, it is also conceivable that the position sensor can detect the entire stroke path of the locking piston 38.

The angle compensation unit 10 further comprises a controller/regulator 116 according to FIG. 5. The sensor device 110 transmits the sensor data of the at least one sensor to the controller/regulator 116. The controller/regulator 116 controls the pressurization of the first pressure chamber 94 and/or the second pressure chamber 102 according to the received sensor data. Furthermore, the controller/regulator determines the forces and/or moments acting on the compensating part 14 as a function of the positional deviation of the compensating position from the basic position.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

### LIST OF REFERENCE NUMBERS

10 angle compensation unit
12 base part
14 compensating part
16 connection housing
18 housing cover
20 cardan housing
22 cardan joint
24 bearing frame
26 bearing flange
28 first pivot pin
29 first axis of rotation
30 first pin receptacle
32 second pivot pin
33 second axis of rotation
34 second pin receptacle
35 plane of the axis of rotation
36 control piston
38 locking piston
40 connection housing top side
42 connection housing bottom side
44 connection housing lateral surface
46 cardan housing top side
48 cardan housing bottom side
50 cardan housing lateral surface
52 compensating part top side
54 compensating part bottom side
56 compensating part lateral surface
58 central recess
60 first guide surface
62 cardan housing base
64 first outer surface
66 flange receptacle
68 second guide surface
70 second outer surface
72 flange bottom side
74 fastening means
76 fastener receptacle
78 end stop
80 flange top side
82 flange surface
84 control surface
86 mandrel
88 pocket
90 first spring means
92 first spring receptacle
94 first pressure chamber
96 first sealing means
98 first pressure line
100 second spring means
102 second pressure chamber
104 second sealing means
106 second pressure line
108 second spring receptacle
110 sensor device
112 signal generator
114 sensor groove
116 controller/regulator

What is claimed:

1. An angle compensation unit for a handling device, having a base part, having a compensating part, having a control piston for controlling the pivoting moment, and having a locking piston for locking the compensating part, wherein the compensating part can be pivoted relative to the base part about an x-axis and about a y-axis running perpendicular to the x-axis between a basic position and a compensating position,
wherein a bearing frame and a bearing flange are arranged in the base part,
wherein the bearing frame is mounted in the base part in a manner allowing rotation about the x-axis,
wherein the bearing flange is mounted in the bearing frame in a manner allowing rotation about the y-axis,
wherein the control piston is displaceable along a z-axis running perpendicular to the x-axis and the y-axis between a control position and a release position,
wherein the locking piston is displaceable along the z-axis between an unlocked position and a locking position,
wherein the locking piston in the locking position compels the control piston in the direction of the control position, and
wherein the control piston locks the compensating part.

2. The angle compensation unit according to claim 1, wherein the compensating part is connected to the bearing flange in a manner preventing movement.

3. The angle compensation unit according to claim 1, wherein the bearing frame has a first axis of rotation running along the x-axis and the bearing flange has a second axis of rotation running along the y-axis, and wherein the first axis of rotation and the second axis of rotation lie in an axis of rotation plane.

4. The angle compensation unit according to claim 1, wherein the bearing frame is rotatably mounted in the base part by first pivot pins and/or the bearing flange is rotatably mounted in the bearing frame by second pivot pins.

5. The angle compensation unit according to claim 1, wherein the bearing frame is ring-shaped and/or the bearing flange is partially spherical.

6. The angle compensation unit according to claim 1, wherein a first spring means is provided for returning the control piston to the control position.

7. The angle compensation unit according to claim 1, wherein a protruding mandrel is provided on the control piston, and a pocket cooperating with the mandrel in the control position is provided on the bearing flange, or wherein a protruding mandrel is provided on the bearing flange and a pocket cooperating with the mandrel in the control position is provided on the control piston.

8. The angle compensation unit according to claim 7, wherein the mandrel and/or the pocket are conical and/or complementary to one another.

9. The angle compensation unit according to claim 7, wherein the mandrel and/or the pocket are designed as inserts.

10. The angle compensation unit according to claim 1, wherein the base part and the control piston delimit a pressurizable first pressure chamber, such that when the first pressure chamber is pressurized, the compensating part is centered.

11. The angle compensation unit according to claim 1, wherein a second spring means is provided for returning the locking piston to the unlocked position.

12. The angle compensation unit according to claim 1, wherein the base part and the locking piston delimit a pressurizable second pressure chamber, such that when the second pressure chamber is pressurized, the compensating part is locked.

13. The angle compensation unit according to claim 11, wherein the first spring means are supported on one end on the control piston and on the other end on the locking piston, and/or wherein the second spring means are supported on one end on the locking piston and on the other end on the base part.

14. The angle compensation unit according claim 1, wherein it has a sensor device with a position sensor for detecting the position of the locking piston and/or the control piston and/or the bearing frame and/or the bearing flange and/or the compensating part, and/or a presence sensor for detecting the presence of a component on the compensating part.

15. The angle compensation unit according to claim 1, wherein at least one end stop is provided on the compensating part to limit the pivoting angle of the compensating part, which end stop contacts a bottom side of the base part in a maximum compensating position.

16. A clamping and/or gripping device, having an angle compensation unit according to claim 1.

17. A handling device having an angle compensation unit according to claim 1.
